(19) United States
(12) Patent Application Publication
(10) Pub. No.: US 2017/0161343 A1
(43) Pub. Date: Jun. 8, 2017

(54) Dataset Analysis Platform

(71) Applicant: Triangulated Data Systems, LLC, Stillwater, MN (US)

(72) Inventors: George Andrew Hoeppner, New Richmond, WI (US); Henry Stanley Spain, Stillwater, MN (US)

(21) Appl. No.: 15/367,915

(22) Filed: Dec. 2, 2016

Related U.S. Application Data
(60) Provisional application No. 62/262,514, filed on Dec. 3, 2015.

(51) Int. Cl. G06F 17/30; G06F 7/552

(52) U.S. Cl. CPC G06F 17/30554; G06F 7/552

(57) ABSTRACT

Deriving information from data is essential to making use of the data prevalent in most aspects of our lives. Currently, we have three standard options in deriving information from the data: average, median, and standard deviation. Each comes with its own flaws, however. Taking an average over simplifies the data. For example, two sets of greatly different data can produce same result: (1, 3, 26)=10 and (10, 10, 10)=10. Medians can be used to solve some problems with taking averages, but you waste data in the process by simply excluding it from analysis. Standard Deviations give you some degree of accounting for deviation in the set, but it can only calculate a range in which the true result lies. Embodiments of the present disclosure may provide a Triangulated Data Score (TDS). TDS gives you beyond a simple average, includes more data than a median, and eliminates guess works of a range.

### RELATED APPLICATION

Under provisions of 35 U.S.C. §119(e), the Applicant claims the benefit of U.S. provisional application No. 62/261,945, filed Dec. 2, 2015, which is incorporated herein by reference. It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to data analytics.

### BACKGROUND

Data analysis is used in scores of ways, including, but not limited to, analysis of sales, employee productivity comparison, evaluation of a student's reading progress, and inventory management. When analyzing a dataset, outliers often skew analysis such that it is difficult to account for deviation and consistency. Often, methods are used including, taking a numerical mean, finding a median value, finding a standard deviation, excluding outliers, or a combination of such methods. However, valuable data may be excluded or overlooked using such methods.

### BRIEF OVERVIEW

A dataset analysis platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure may provide a Triangulated Data Score (TDS). Deriving information from data is essential to making use of the data prevalent in most aspects of our lives. Currently, we have three standard options in deriving information from the data: average, median, and standard deviation. Each comes with its own flaws, however. Taking an average over simplifies the data. For example, two sets of greatly different data can produce same result: (1, 3, 26) =10 and (10, 10, 10) =10. Medians can be used to solve some problems with taking averages, but you waste data in the process by simply excluding it from analysis. Standard Deviations give you some degree of accounting for deviation in the set, but it can only calculate a range in which the true result lies. So, you may end up with an idea but have no certainty where in that range the true result lies. TDS solves these problems to make your data smarter and results better. TDS gives you beyond a simple average, includes more data than a median, and eliminates guess works of a range. Applications can include the stock market, academic grading, fantasy sports, employee performance, exercise, and many more applications.

A TDS platform may comprise a mathematical process that takes sets of data and drives them to one, final answer that accounts for consistency and deviation. The TDS platform can be used to analyze data and deliver a score that predicts consistency or one that will anticipate a strong deviation. This process is done by taking every possible pair of data points created by the set of data and “triangulating” them through the mathematical process. Each pair of data points creates new data that are then analyzed so that an outcome may be reached. The type of outcome may be user defined. The TDS can be used in its original state to analyze and reward consistency where the user is searching for a set of data with low deviation or applied to a further process to reward volatility where the user is looking for data with a high deviation.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a dataset analysis platform;

FIG. 3 illustrates a dataset and resulting calculations; and

FIG. 4 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of educational usage, embodiments of the present disclosure are not limited to use only in this context.

I. Platform Overview

Consistent with embodiments of the present disclosure, a dataset analysis platform may be provided. This overview is provided to introduce a selection of concepts in a simplified form that are further described below. This overview is not intended to identify key features or essential features of the claimed subject matter. Nor is this overview intended to be used to limit the claimed subject matter's scope. The dataset analysis platform may be used to eliminate complexity of a dataset while accounting for both volatility and consistency.

The dataset analysis platform may intake data. The platform may then condense the data into an easy to use, easy to understand, and easy to implement number or set of numbers. Wherever there is data that needs to be interpreted, the platform may take the guess work out of the numbers and help users interpret the data as a whole. Further, the platform may take into account consistency and volatility of the data. In this way, the platform may enable users to make smart decisions based on the analyzed data. A variety of processes may implement the platform to enable users to make better decisions and achieve better results.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

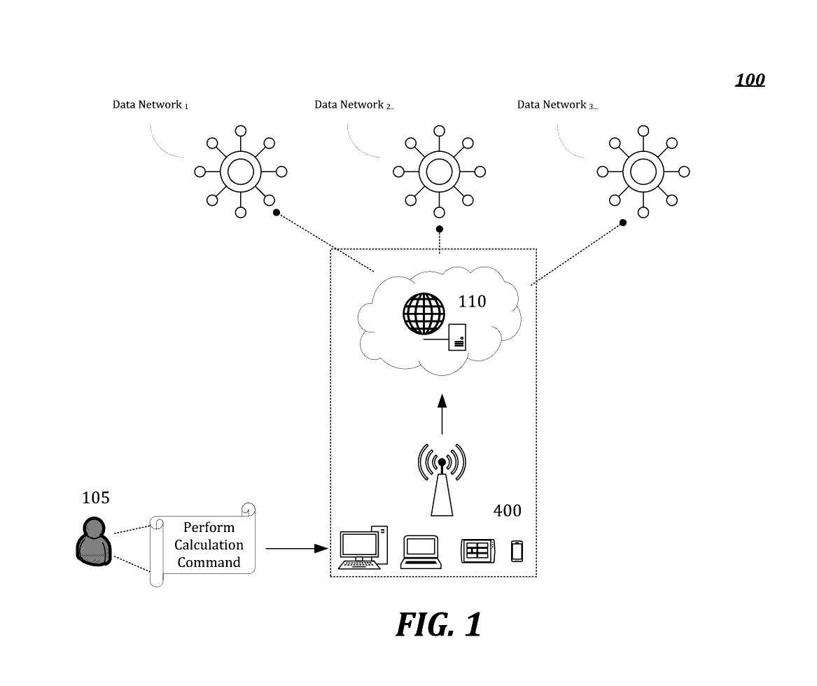

FIG. 1 illustrates one possible operating environment through which a platform consistent with embodiments of the present disclosure may be provided. By way of non-limiting example, a dataset analysis platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 400.

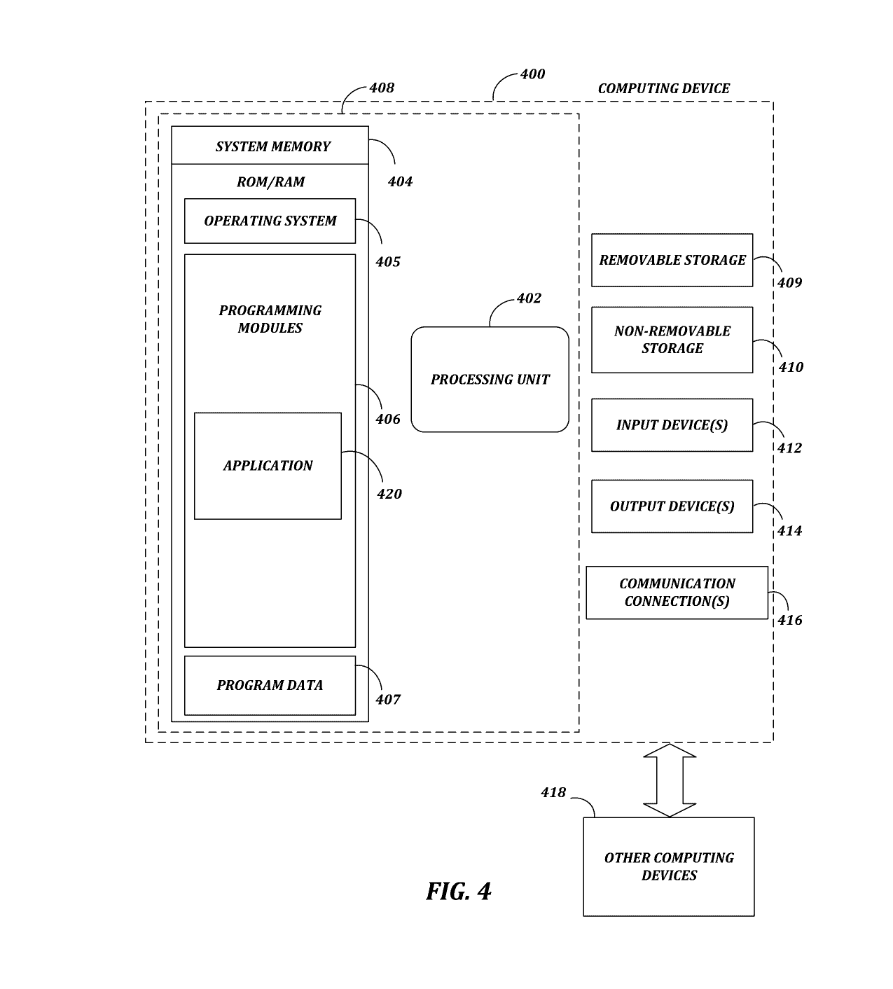

As will be detailed with reference to FIG. 4 below, the computing device through which the platform may be accessed may comprise, but not be limited to, for example, a desktop computer, laptop, a tablet, or mobile telecommunications device. Though the present disclosure is written with reference to a server or desktop computer, it should be understood that any computing device may be employed to provide the various embodiments disclosed herein.

Platform 100 may be in operative communication with a plurality of data networks. The data networks may provide a plurality of datasets for which platform 100 may process in accordance to section (III) below.

III. Platform Operation

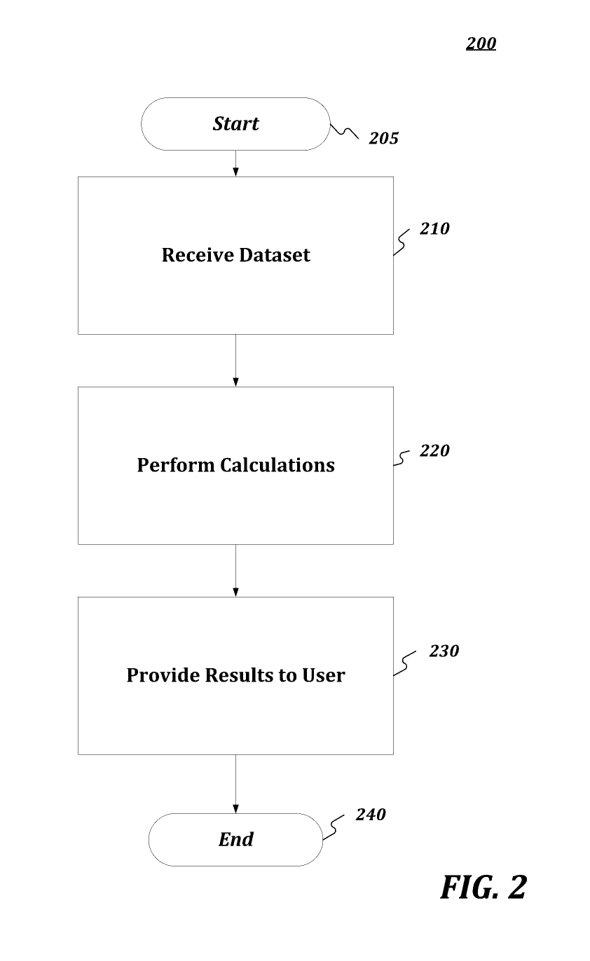

FIG. 2 is a flow chart setting forth the general stages involved in a method 200 consistent with an embodiment of the disclosure for providing dataset analysis platform 100.

Method 200 may be implemented using a computing device 400 as described in more detail below with respect to FIG. 4.

Although method 200 has been described to be performed by computing device 400, it should be understood that, in some embodiments, different operations may be performed by different networked elements in operative communication with computing device 400.

For example, server 110 and/or computing device 400 may be employed in the performance of some or all of the stages in method 200. Moreover, server 110 may be configured much like computing device 400 and, in some instances, be one and the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where computing device 400 may receive a dataset comprising numbers. For example, the dataset may comprise integers, rational, and irrational numbers. Computing device 400 may receive the numbers, by receiving manual input from a user or by importing the dataset, including, but not limited to, a .csv file. In some embodiments, the dataset may be received from a network communication such as, for example, but not limited to an application programming interface (API).

From stage 210, where computing device 400 receives the dataset comprising numbers, method 200 may advance to stage 220 where computing device 400 may perform calculations. For example, the platform may calculate one or more values to summarize the data. The one or more values may comprise a consistency triangulated data score, or “cTDS.” The cTDS may be calculated as each number in the dataset squared and each resulting value multiplied by each other, the product then taken to the 2n root, where n is the number of datapoints. The formula below may be used to find the cTDS, for a dataset {x₁, x₂, x₃, . . . , xₙ} comprising n datapoints.

cTDS=ⁿ\sqrt{x₁*x₂*x₃* . . . *xₙ}

Further, a deviation or volatility Triangulated Data Score, or “vTDS,” may be used to represent the volatility of the dataset. The vTDS may be calculated from the cTDS as follows:

$$vTDS = ( 1 - \frac{cTDS * n}{{x}_{1} + {x}_{2} + {x}_{3} + … + {x}_{n}} ) \frac{{x}_{1} + {x}_{2} + {x}_{3} + … + {x}_{n}}{n}$$

Still further, another value, a “wTDS,” may be calculated to illustrate the deviation and volatility of the dataset by using a maximum value of the dataset. The wTDS may be calculated as follows:

$$wTDS = ( 1 - \frac{cTDS * n}{{x}_{1} + {x}_{2} + {x}_{3} + … + {x}_{n}} ) MAXIMUM \{ {x}_{1} , {x}_{2} , {x}_{3} , … , {x}_{n} \}$$

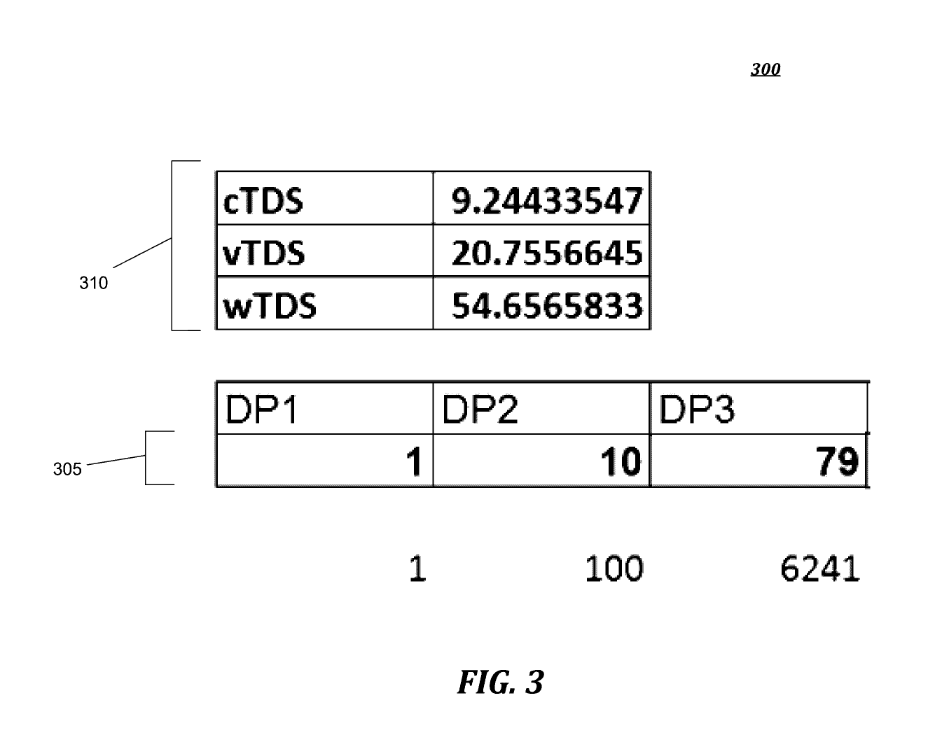

FIG. 3 illustrates an embodiment 300 of the present disclosure performed by an excel spreadsheet on dataset 305, producing summarizing values 310.

Once computing device 400 performs calculations in stage 220, method 200 may continue to stage 230 where computing device 400 may provide results of the calculations to a user. For example, the software may provide the one or more values to summarize the data (e.g. cTDS, vTDS and wTDS) to the user on a computer screen. For example, in a spreadsheet, each formula may be calculated on a page with all the different datasets. By simply setting a condition (highest cTDS, lowest vTDS, etc.) you could have the dataset displayed that satisfied your condition. Also, you could set the function to give you the dataset that came closest to a given requisite (i.e. cTDS closest to 20). Further, the data may be plotted with the one or more values to summarize the data in a plot. In yet further embodiments, the platform may receive a plurality of datasets and provide a report by utilizing the one or more values to summarize the data.

For example, in current practice today, student reading levels are calculated by having the student read three passages, eliminating the high and low, and stating that the student's reading level is the median of the three scores. This practice eliminates two-thirds of the data collected and wastes two-thirds of the teacher's time. This is done under the guise that maybe the low passage was of little interest to the student, they were bored or distracted. The high score is dismissed by saying that maybe the student had prior knowledge of the subject matter or had seen some of the words before. The platform may enable teachers to acknowledge that all of those “explanations” are part of who that student is as a reader. They may struggle with focus, they may be disinterested in some subject matter and have a strong prior knowledge of others. By using cTDS, the teachers may get a clearer, more complete picture of who students are, and all of the data collected may be usable. Essentially, the cTDS can be a good way of calculating an indicativce value that cannot be ascertained from the ‘means’ and ‘medians’ in the data.

cTDS can give you the dataset that provides the best set of values for predicting a high expected return. For example, how two different stocks have performed and which one could be expected to have the highest return in the future. On the contrary, vTDS and wTDS provide the most volatility expected. If you wanted a smaller, assured return you would look to the highest cTDS as your choice. However, if you wanted the risk that comes with the highest volatility, vTDS and wTDS would be your best choices.

As another use of the platform, in fantasy football individuals oftentimes need a fill-in for one week. You peruse the available players and look at their average scores thus far through the season. But what an individual needs varies greatly depending on the makeup of the rest of the team. For example, if you have a strong team and need a player who may not score the most points but you want to be as sure as possible that they will get you a minimum number of points, you would use cTDS. If the team is struggling and an individual wants to see which player is the most likely to have a scoring outburst, vTDS or wTDS would be the better process as they will assess which player, given their scoring history, has the largest volatility and could produce a high single week score.

Further embodiments may be used for assessing the stock market in both the short and long term for purposes of varying investment strategies.

Once computing device 400 provide results of the calculations to the user in stage 230, method 200 may then end at stage 240.

IV. Platform Architecture

The dataset analysis platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 200 has been described to be performed by a computing device 400, it should be understood that, in some embodiments, different operations may be performed by different networked elements in operative communication with computing device 400.

Embodiments of the present disclosure may comprise a system having a memory storage and a processing unit. The processing unit may be coupled to the memory storage, wherein the processing unit is configured to perform the stages of method 200.

FIG. 4 is a block diagram of a system including computing device 400. Consistent with an embodiment of the disclosure, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the disclosure.

With reference to FIG. 4, a system consistent with an embodiment of the disclosure may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include numerical calculation application 420. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., numerical calculation application 420) may perform processes including, for example, one or more of method 200's stages as described above. The aforementioned process is an example, and processing unit 402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a dataset comprising numbers;
performing a consistency triangulated data score (cTDS) calculation; and
providing the cTDS result.

2. The method of claim 1, wherein the cTDS is calculated as each number in the dataset squared and each resulting value multiplied by each other, the product then taken to the 2n root, where n is the number of data points.

3. The method of claim 1, wherein the cTDS is calculated as
cTDS=ⁿ\sqrt{x₁*x₂*x₃* . . . *xₙ}

4. The method of claim 1, further comprising calculating a volatility triangulated data score (vTDS) to represent volatility of the dataset.

5. The method of claim 4, wherein the vTDS is calculated as
$$vTDS = ( 1 - \frac{cTDS * n}{{x}_{1} + {x}_{2} + {x}_{3} + … + {x}_{n}} ) \frac{{x}_{1} + {x}_{2} + {x}_{3} + … + {x}_{n}}{n}$$

6. The method of claim 4, further comprising providing the vTDS result.

7. The method of claim 1, further comprising calculating a wTDS to illustrate the deviation and volatility of the dataset by using a maximum value of the dataset.

8. The method of claim 7, wherein the wTDS is calculated as
$$wTDS = ( 1 - \frac{cTDS * n}{{x}_{1} + {x}_{2} + {x}_{3} + … + {x}_{n}} ) MAXIMUM \{ {x}_{1} , {x}_{2} , {x}_{3} , … , {x}_{n} \}$$

9. The method of claim 7, further comprising providing the wTDS result.

10. The method of claim 1, wherein the data set comprises integers, rational, and irrational numbers.
